(19) United States
(12) Patent Application Publication
(10) Pub. No.: US 2007/0176774 A1
(43) Pub. Date: Aug. 2, 2007

(54) Imbedded intelligent water and device monitoring system

(75) Inventors: Peter J. Jahrling, Park Ridge, IL (US); John R. Wilson, Naperville, IL (US)

Correspondence Address: FOLEY & LARDNER LLP, 321 NORTH CLARK STREET, SUITE 2800, CHICAGO, IL, 60610-4764, US

(73) Assignee: Sloan Valve Company

(21) Appl. No.: 11/701,216

(22) Filed: Feb. 1, 2007

Related U.S. Application Data
(60) Provisional application No. 60/764,531, filed on Feb. 1, 2006.

(51) Int. Cl. G08B 1/08

(52) U.S. Cl. 340/539.26

(57) ABSTRACT

A method and system for harvesting potential energy from a commercial restroom system as well as monitoring and controlling the system. The method and system includes parallel combinations of energy generators converting passively, in the case of photovoltaic cells and heat to power conversion devices, and converting energy actively, in the case of water turbines, vibration generating devices, and fractional energy sources connected to powered devices. The method and system are employed to give longer life to on board powered devices, and to give momentary power to manual devices which can then communicate using the power generated by the mechanical activation or fractional power source output of the device.

### CROSS-REFERENCE TO RELATED PATENT APPLICATION

This application claims priority from U.S. Provisional Patent Application 60/764,531 filed Feb. 1, 2006, herein incorporated by reference in its entirety.

### FIELD OF THE INVENTION

The present invention is directed generally to a method and system for enhancing the monitoring and controlling of sanitary, health and environmental systems by harvesting excel potential energy. More particularly the invention is related to methods and systems of generating power to aid in monitoring and/or controlling washroom facilities.

### BACKGROUND OF THE INVENTION

In commercial applications, multiple fixtures are necessary to service users within various public areas such as washrooms. With multiple flushometer valves and faucets within close proximity of each other in both men and women's restrooms, each fixture operates randomly. Each fixture will experience use as a direct relationship to the traffic the facility sees as well as the physical restroom layout. In recent years, automatic activated flushometers and faucets have found popularity because of their hygiene features and a desire on the part of owners to have automatic activation of these devices. Along with this hygiene in recent years has come the desire to save water and monitor this savings, as well as have the automatic devices become self diagnosing for problems. LEED, The Leadership in Energy and Environmental Design, is an initiative sponsored by the Green Building Council http://www.usgbc.org/DisplayPage.aspx?CategoryID=19 to guide building designers, owners and operators with tools to impact a buildings performance. This is done by establishing guidelines of points awarded building designs for using less resources below an established standard in 5 measurable areas of human and environmental health. One of those areas is water savings. With LEED certified buildings and specifications, a new niche of more advanced water saving and self diagnosing systems is desired. Having otherwise disjointed electronic flushometers and fixtures operate within a monitored system can further advance diagnostics and water savings.

With electronic plumbing fixtures, electronic control is already on board; and with added capability this control can take on more processing power to assist in making the electronic product more productive and predictive. Connecting electronic plumbing fixtures by wires can accomplish the task of inter fixture communication and supplying power to those fixtures. (For example, the assignee of this patent has an institutional line of products that wires plumbing devices within a prison to control the plumbing fixtures.) With unlimited power to plumbing electronic fixtures, the electronic fixture control can take on added capability. With each individual fixture wired for communication, a central information system can process activations and predict maintenance schedules based upon use. Manually wiring of individual (discrete) electronic fixtures adds considerable expense beyond the electronic flushometers and faucets. Eliminating this added installation expense can advance the art of water savings operational and maintenance expense. Allowing fixtures to communicate wirelessly adds to the on board power requirements a discrete device will need beyond the operational power requirements of detecting users and turning water on and off. This has brought to the forefront the need for electronic devices which can operate without hard wiring and which require them to be more energy efficient in their operation, and power added functions.

In the working environment of an electronic plumbing fixture one can harvest some modest amounts of kinetic energy for powering the device from the combined light, water flow, and pipe vibration (see U.S. Pat. No. 7,142,075 Micromechanical Power Generator). Using small solar panels, the commercial restroom light can be transformed into power. By normally operating flush valves and faucets, power can be generated by transforming naturally occurring mechanical movement into small amounts of energy (U.S. Pat. No. 6,885,114). Power generation by water powered turbines are also known in the art. There exists in the market electronic plumbing products (flush valves and faucets) that generate supplemental power by harvesting available energy, such as power from light and kinetic energy from pressurized water. U.S. Pat. Nos. 7,075,768 and 6,876,100 teach how to harness power with a turbine on an automatic faucet or flush valve to supplement the faucet or flush valve's primary battery power supply. These teachings dedicate the turbine to the individual plumbing device but have inherent problems with their location positioned towards the user discharge point. (Moving the turbine upstream of the plumbing devices can take advantage of larger piping and greater flow from multiple fixtures which will not affect additional pressure drops within the individual plumbing device itself. This will also allow power to be distributed to more than one plumbing device) U.S. Pat. No. 6,938,280 teaches generating power with solar cell (photovoltaic cell) to an automatic faucet or flush valve to supplement the faucet or flush valve's primary battery power supply. These types of power supplement to plumbing products enhances their attractiveness to LEED certified buildings by extending battery life and reducing power cell (battery) disposal. This results in reduced land fill pollution or special handling of non-alkaline power cells. In addition, these power harvesting devices take advantage of potential power existing in commercial restroom lighting and water pressure in the commercial plumbing water pipes. While these technologies supplement battery power, other technologies extend battery life by reducing operating energy by being more efficient.

Commercial applications typically have more robust plumbing systems, particularly as a direct result of flushometers needing higher pressure and flow. Within each activation of a flushometer, there is kinetic energy in the water flow, beyond that energy used to evacuate a fixture. This kinetic energy is imparted into the water supply by the pumps which increase the water pressure in commercial applications.

It is therefore desirable to harness the excess kinetic energy within the water supply in an effort to assist in powering automatic plumbing flushometers and faucets. Since these automatic devices are powered, it is also desirable to use microprocessor controlled logic to allow for the devices to diagnose their operational conditions. Beyond simple detection and fixture activation by the electronics, more powerful microprocessors allows more advanced operations to be installed in the flushometers and faucets which allows for the individual fixtures to exist within a local and global network, exchanging information within those networks. Beyond manual fixtures, automatic fixtures can take on individual uniqueness and report to higher level intelligence systems the condition of the individual device within its operational sphere.

There also exists in commercial restrooms, many manually operated dispensing devices, such as soap dispensers, hand sanitizer dispensers, towel dispensers, and toilet tissue paper dispensers. Each of these devices is installed so the owner of a restroom can supply economically the various consumables needed for restroom patrons. Some of these devices have even evolved in recent years into automatic dispensers further keeping patrons from otherwise having to touch mechanical surfaces. While automatic dispensing devices for consumables can leverage the on-board microprocessor to enhance the dispensing devices intelligence, the majority of dispensers within the market are manual with no electronic intelligence. All these manual consumable dispensers operate by the user exerting some mechanical urging to operate the device in order to obtain the desired portion of consumable. One of the major problems with these multiple dispensers is keeping them full or “topped off” if a bulk product is used to fill them. With multiple dispensers within a singular commercial restroom, some dispensers are more frequented by traffic patterns; and these dispensers may become depleted faster than other dispensers in the room which are not as frequently used because of traffic patterns or restroom layout.

In view of all the above-mentioned shortcomings of washroom operating conditions and washroom device operations, there is a substantial need for a coordinated and global solution. This solution will be energy efficient while providing on demand, all necessary commodities and necessary power for proper operation and maintenance of the facility and associated electronic devices, as well as providing hygienic conditions for patrons.

### SUMMARY OF THE INVENTION

This invention advantageously incorporates multiple technologies within an electronic plumbing device and in washroom systems and components to augment and supplement on board energy and to capture and convert kinetic energy from its environment into usable energy for the device. With more energy efficient plumbing devices, one can accomplish more tasks to reduce overall operating costs. The invention utilizes previously developed water turbines to generate energy from the water flow. The invention also uses passive solar cells (photovoltaic cells) to generate power from the light. Vibrating devices can also be used to add yet another form of energy conversion. Exothermic heat transfer devices, can convert hot water temperature convection into power. A hand operated soap dispenser whose pumping power is supplied by a user dispensing soap, can urge a small microgenerator to power a small RF transmitter. This transmitter can send a signal of activation so that an otherwise visual manual liquid level (which presently determines soap replacement) can be determined by digital counting to a restroom receiving module. Other highly efficient, conventional portable power sources can also be used to provide long term energy for powering wireless device operation. These features and other attributes of the invention are described hereinafter in more detail and shown in the drawing described hereinbelow.

### BRIEF DESCRIPTION OF THE DRAWING

FIG. 1 illustrates an embodiment of an embedded intelligent water and device monitoring system.

### DETAILED DESCRIPTION OF PREFERRED EMBODIMENTS

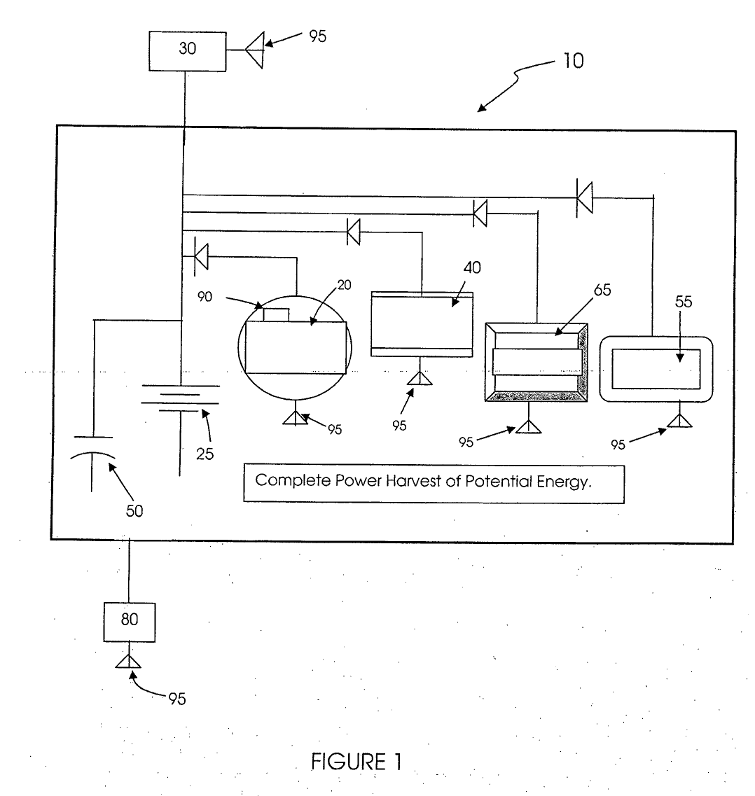

A preferred form of the invention is illustrated generally at 10 in FIG. 1. A properly sized water powered turbine 20 can be placed to generate power from water flow in the system 10. Along with an on board power cell 25 (such as batteries), the turbine 20 can supplement the power needs of an electronic device fixture 30. Locating the turbine 20 upstream of the plumbing device (not shown), puts the turbine 20 into piping channels that are large and have more flow than at the specific fixture as opposed to having just one turbine per plumbing fixture. In addition to the water turbine 20 this system 10 also can include a solar collector 40 coupled to the electronic faucet or flush valve to harvest energy from the ambient light to supplement the needed power. This system 10 also can incorporate passive infrared detection to minimize on board power required to operate the electronic flush valve and electronic faucet. Passive infrared detection needs less power than active infrared, and this technology along with a turbine power and solar collector 40 further reduces the power needs of an electronic flush valve and an electronic faucet. This system 10 also includes water monitoring by counting the turbine rotation and translating that to water passage and associated information. These alternative energy sources can selectively feed a secondary energy storage system 50 recharge a primary battery 25. Most preferably the system 10 feeds the secondary storage system 50.

A properly sized form of the water powered turbine 20 is located upstream of the plumbing device. Placement of the turbine 20 further upstream of the plumbing device takes advantage of larger pipe size and more available water flow than downstream or even proximate to the ultimate pressure drop at the plumbing device's exit point. The water flow thus rotates the turbine 20 which generates current which can be stored within an electronic device for use or output to the storage system 50 described hereinbelow.

The secondary storage system 50 can be a supercapacitor which is an electrochemical capacitor that has, for example, unusually high energy density (when compared to common capacitors) and extremely low standby discharge rates. The stored energy within the supercapacitor, supplements power from the primary battery 25.

Along with the water turbine 20 generating power from water flow, the solar collector 40 can convert energy from the restroom or ambient light whenever the light is present in the restroom. The program logic of electronic control system 80 uses the power generated by the water flow to power a detection circuit associated with each of the electronic fixtures 30. The program logic of the electronic control system 80 uses the power generated by the solar collector 40 to power a solenoid firing system (not shown). This logic within the electronic flush valve or faucet (one of the electronic fixtures 30) uses the prolonged exposure to light and the solar collector conversion assures available energy for turning the water on and off via a energy conserving latching solenoid. The control system 80 can include a microprocessor chip or other such device) for monitoring and processing data for all operational processes described herein. The electronic control system 80 can also monitor energy needs within the system 10 and route needed energy to the appropriate washroom electronic fixtures or devices 30 or to the storage system 50. The electronic control system 80 also can monitor operating status of the plurality of the washroom electronic devices 30, or monitor a fractional energy source 65 to be described hereinbelow. This computer monitoring can be accomplished by computer software protocols executed by the electronic control system 80 or its hardware equivalent.

The above-mentioned fractional energy sources 65 can be, for example, a fuel cell, miniature atomic power source, a hot water convection energy converter, a solid state hydrogen source or other conventional energy source. The fractional energy source 55 can even include a patron's mechanically applied forces in accessing one of the washroom devices to power an RF transmitter. This will allow supply information of the consumable to be output to the system 10 to enable device operability and to monitor commodity used or remaining in the washroom electronic devices 30, such as liquid or paper dispensers.

Along with the power generating turbine 20 a sensor device 90 can be employed to sense the turbine rotation. Since the turbine 20 can count the number of rotations by the passage of water in a known channel, the turbine 20 can thus determine the amount of water that has flowed, as well as determine if water flow is in fact moving and at what velocity and/or pressure. With appropriate logic, if a particular washroom electronic device 30 is not supposed to be in a flowing condition based upon target detection and mode of operation, a warning signal can be generated along a communication link 95 from the individual of the washroom device or valve to a person, or to a monitor or a network, not shown. In this manner, the system 10 can diagnose and potentially control any problems before expensive damage is incurred. The communication link 95 can, for example, be an RF communication, an optical source (such as an infrared beam), and a visual display for generating information.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments, and with various modifications, as are suited to the particular use contemplated.

What is claimed is:

1. A system for monitoring and control of a washroom, comprising,
a plurality of washroom electronic devices;
a plurality of different types of fractional energy sources, at least one of the washroom electronic devices receiving energy from multiple fractional energy sources; and
a control system for receiving information from each of the plurality of washroom electronic devices, thereby monitoring and controlling the plurality of washroom electronic devices.

2. The system as defined in claim 1 further including at least one of a wireless communication, an optical source, visual or not visual coupled to each of the plurality of washroom electronic devices for communicating operational status and usage information to and/or from the control system.

3. The system as defined in claim 1 further including a wireless communication coupled to each of the plurality of washroom electronic devices for communicating operational status and usage information from the fractional energy sources.

4. The system as defined in claim 1 wherein the plurality of washroom electronic devices comprises at least one of a faucet, a urinal, a toilet, a soap dispenser, an air purifier, a deodorizer, a tissue dispenser and a towel dispenser.

5. The system as defined in claim 1, wherein the fractional energy sources comprise at least one of a solid state battery, a solar cell, a fuel cell, a water turbine and a hot water convection device.

6. The system as defined in claim 1 further including at least one electronic control system having a memory which acts to route fractional energy to a selected one of the electronic devices as needed.

7. The system as defined in claim 1 further including a secondary storage system for accumulating energy for use by the washroom electronic devices.

8. The system as defined in claim 6 further including a secondary storage system for accumulating energy for use by the washroom electronic devices.

9. The system as defined in claim 1 further including an efficiency management protocol embedded in a electronic control system for management of at least one of water usage information from the system, consumable usage information and energy usage information from the system.

10. The system as defined in claim 1 further including an operational status management protocol embedded in a electronic control system for monitoring operating status of at least one of the plurality of washroom electronic devices and the plurality of different fractional energy sources.

11. The system as defined in claim 1, wherein the turbine is disposed upstream of a plumbing device.
